(19) United States
(12) Patent Application Publication
(10) Pub. No.: US 2012/0109646 A1
(43) Pub. Date: May 3, 2012

(54) SPEAKER ADAPTATION METHOD AND APPARATUS

(75) Inventor: Eun-Sang BAK, Ansan-si (KR)

(73) Assignee: SAMSUNG ELECTRONICS CO., LTD., Suwon-si (KR)

(21) Appl. No.: 13/224,489

(22) Filed: Sep. 2, 2011

(30) Foreign Application Priority Data
Nov. 2, 2010 (KR) 10-2010-0108390

(51) Int. Cl. G10L 19/02

(52) U.S. Cl. 704/229; 704/E19.001

(57) ABSTRACT

A speaker adaptation method and apparatus are provided including extracting adapted data from speech recognition data stored in a database, and modifying a sound model by using a speaker adaptation method selected based on a type of the extracted adapted data.

### CROSS-REFERENCE TO RELATED PATENT APPLICATION

This application claims priority from Korean Patent Application No. 10-2010-0108390, filed on Nov. 2, 2010, in the Korean Intellectual Property Office, the disclosure of which is incorporated herein in its entirety by reference.

### BACKGROUND

1. Field

Methods and apparatuses consistent with exemplary embodiments relate to speaker adaptation methods and apparatuses, which select adapted data and use different adaptation methods according to a kind of the selected adapted data.

2. Description of the Related Art

Speech recognition technologies for controlling various machines by using speech signals have been developed. Speech recognition technologies are classified as speaker-dependent technologies or speaker-independent technologies depending on the speaker who is the subject of recognition.

Speaker-dependent technologies are used to recognize the speech of a specific speaker, and to recognize the speech of the specific speaker by comparing an input speech pattern with a previously-stored speech pattern of the user's speech.

Speaker-independent technologies are used to recognize the speech of a plurality of non-specific speakers, and to recognize the speech of the non-specific speakers based on acquired statistical models developed by collecting the speech patterns of many non-specific speakers.

Recently, technologies for modifying speech models established from a speaker-independent point of view so as to be suitable for recognizing a specific speaker by using data obtained from the specific speaker have been developed, and are referred to as speech adaptation technologies.

### SUMMARY

One or more embodiments provide speaker adaptation methods and apparatuses, which select adapted data from data on which speech recognition has been performed and, use a different adaptation methods according to the kind of the selected adapted data.

In accordance with an aspect of an exemplary embodiment, there is provided a speaker adaptation method including extracting adapted data from speech recognition data stored in a database, where the stored speech recognition data includes a first type of data and a second type of data; selecting a speaker adaptation method according to whether the extracted data is the first type of data or the second type of data, and modifying a sound model by using the selected speaker adaptation method.

The speaker adaptation method may further include storing the speech recognition data in the database, wherein the speech recognition data may include input speech data on which speech recognition has been performed using a sound model.

The first type of data may include speech recognition data for which the speech recognition was correctly performed and the second type of data may include speech recognition data for which the speech recognition was not correctly performed, and the storing of the speech recognition data may include sorting the speech recognition data according to whether the speech recognition is the first type of data or the second type of data.

The first type of data may include text data generated by recognizing the input speech data, in addition to the input speech data.

The second type of data may include text data generated when an error in text data generated by recognizing the input speech data was corrected, in addition to the input speech data.

The extracting of the adapted data may include, extracting the second type of data in an order beginning with speech recognition data containing most words with a highest error occurrence.

The extracting of the adapted data may include extracting the adapted data in an order beginning with speech recognition data containing speech data with lowest similarity to a pattern of the sound mode.

The extracting of the adapted data may include extracting the adapted data in an order beginning with speech recognition data containing speech data containing most words that are most frequently used.

The modifying of the sound model may include, when the extracted data is the first type of data, modifying the sound model by using a global adaptation method using the extracted adapted data.

The global adaptation method may be a maximum probability linear regression (MLLR) method.

The modifying of the sound model may include, when the extracted data is the second type of data, modifying the sound model by using a local adaptation method using the extracted adapted data.

The local adaptation method may include a maximum a posteriori (MAP) method.

In accordance with an aspect of another exemplary embodiment, there is provided a speaker adaptation apparatus including a database in which speech recognition data is stored, wherein the speech recognition data comprises a first type of data and a second type of data; an adapted data extracting unit for extracting adapted data from speech recognition data stored in the database; and a speaker adaptation unit for modifying a sound model by using another speaker adaptation method based on whether the extracted data is the first type of data or the second type of data.

According to an aspect of another exemplary embodiment, there is provided a non-transitory computer readable recording medium having recorded thereon a program for executing a method including extracting adapted data from speech recognition data stored in a database wherein the stored speech recognition data comprises a first type of data and a second type of data; selecting a speaker adaptation method according to whether the extracted data comprises the first type of data or the second type of data; and modifying a sound model by using the selected speaker adaptation method.

According to an aspect of an exemplary embodiment, a speaker adaptation method and apparatus selects adapted data from data on which speech recognition is performed, and uses different adaptation methods according to the type of the selected adapted data.

### BRIEF DESCRIPTION OF THE DRAWINGS

The above and/or other aspects and advantages will become more apparent from the following description of exemplary embodiments with reference to the attached drawings in which:

FIG. 1 is a block diagram of a speaker adaptation apparatus according to an exemplary embodiment;

FIGS. 2A and 2B show speech recognition data stored in a database being changed when speech recognition is normally performed, and when speech recognition is not normally performed, respectively;

FIG. 3 is a flowchart of a speaker adaptation method according to an exemplary embodiment;

FIG. 4 is a flowchart of an operation of FIG. 3, according to an exemplary embodiment;

FIG. 5 is a flowchart of an operation of FIG. 3, according to an exemplary embodiment; and

FIG. 6 is a flowchart of an operation of FIG. 3, according to an exemplary embodiment.

### DETAILED DESCRIPTION

A speech recognition apparatus analyzes speech signals, and performs various operations according to the speech signals. The speech recognition apparatus obtains a recognition result by establishing a sound model, comparing an input unknown speech signal with standard patterns stored in the sound model, and finding a pattern most similar to a pattern of the input unknown speech signal.

The speech recognition apparatus extracts and stores the characteristics of speech patterns in order to establish the sound model. Technologies for establishing the sound model may be classified as speaker-dependent technologies, speaker-independent technologies, and speaker adaptation technologies according to the speaker who is the subject of recognition.

Exemplary embodiments relate to a speaker adaptation technology of modifying a sound model established based on speaker-independent technology so as to be suitable for a specific speaker.

Exemplary embodiments will now be described more fully with reference to the accompanying drawings.

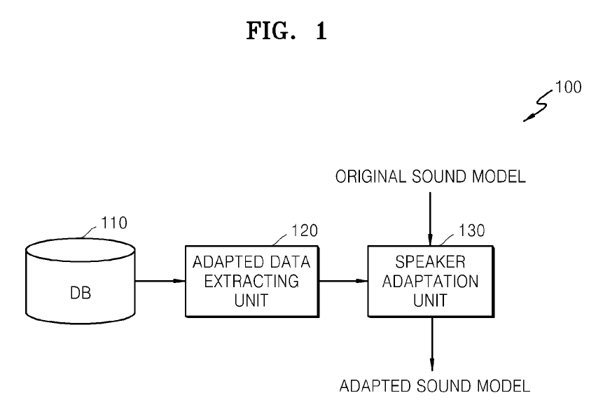

FIG. 1 is a block diagram of a speaker adaptation apparatus 100 according to an exemplary embodiment. The speaker adaptation apparatus 100 is included in a speech recognition apparatus (not shown), and converts an original sound model into one that is suitable for a specific speaker.

Referring to FIG. 1, the speaker adaptation apparatus 100 includes a database 110, an adapted data extracting unit 120, and a speaker adaptation unit 130.

The speech recognition apparatus may further include an input unit and an output unit, in addition to the speaker adaptation apparatus 100. The input unit is a physical transducer such as a keyboard, a mouse, a touch pad, a touch screen, or a microphone, and transfers instruction data, character data, number data, speech data, or the like from a user, that is, a speaker, to the speech recognition apparatus.

The output unit may be a screen, an audio speaker, or the like, and outputs an overall state of the speech recognition apparatus or information input by the user through the input unit.

When a speaker provides speech data, the speech recognition apparatus recognizes speech by extracting a characteristic parameter or a characteristic vector from the provided speech data and performing pattern matching between the extracted characteristic parameter or the characteristic vector, and an original sound model.

The speech recognition apparatus may correctly recognize the speech data provided by the speaker as he or she intended, or may not correctly recognize the speech data. For example, when the speaker inputs the speech data in a very noisy environment, or has a unique linguistic habit, the speech recognition apparatus may not precisely recognize the provided speech data as the speaker intended.

Through the output unit, the speech recognition apparatus may output a result of the speech recognition performed on the input speech data. For example, when the user, that is, the speaker, tries to write a text message, a memo, or the like by inputting speech data, the speech recognition apparatus may perform speech recognition on the input speech data, and may output the result of the speech recognition in the form of text data to be input into a text message, a memo, or the like.

The speaker may then determine whether the speech data he or she has provided has been correctly recognized or whether errors have occurred, by using the data output from the speech recognition apparatus. That is, in the above-mentioned example, the speaker may determine whether the text data output from the speech recognition apparatus corresponds to the input data as intended by the speaker.

Using the input unit included in the speech recognition apparatus, such as a key board, a speaker, or the like, the speaker may input information to the speech recognition apparatus indicating whether the speech recognition has been normally (correctly) performed.

When the speaker determines that the speech data has not been correctly recognized by the speech recognition apparatus, that is, when data output through the output unit does not correspond to the input speech data as provided by the speaker, the speaker may correct the errors in the output data by using the input unit. In the above-mentioned example, when a phoneme or a word that was not intended by the speaker is included in the text data output from the speech recognition apparatus, the speaker may correct the text data as originally intended.

The speaker adaptation apparatus 100 included in the speech recognition apparatus receives, through the input unit, the information indicating whether the speech recognition has been correctly performed, and sorts and stores speech data on which the speech recognition has been correctly performed and also speech data in which speech recognition errors have occurred. The speaker adaptation apparatus 100 inserts the speech data into speech recognition data, and stores the speech data in the database 110.

The speech recognition data includes input speech data, or a characteristic vector or a characteristic parameter of the input speech data, and text data corresponding to the input speech data generated when the speech recognition is correctly performed on the input speech data.

When the speech recognition is correctly performed, that is, when the speaker adaptation apparatus 100 receives from the speaker information indicating that the speech recognition has been correctly performed, the speaker adaptation apparatus 100 binds together the speech data provided an input by the speaker, a characteristic parameter or a characteristic vector that is extracted from the input speech data, and text data generated by performing the speech recognition on the input speech data, and stores the bound data in the database 110.

When errors occur in the speech recognition, and the speaker corrects the text data, the speaker adaptation apparatus 100 binds together the input speech data provided by the speaker, the characteristic vector or the characteristic parameter that is extracted from the input speech data, and the corrected text data in which errors have been corrected, and stores the bound data as the speech recognition data in the database 110.

When speech data is recognized by using the original sound model, the database 110 may further store data about a similarity between parameters of the input speech data and parameters of the original sound model as a log probability value.

The adapted data extracting unit 120 extracts adapted data from the speech recognition data stored in the database 110.

The adapted data extracting unit 120 extracts the adapted data that is suitable for the speaker from each of a group of the speech recognition data on which the speech recognition is successfully performed, and a group of the speech recognition data in which speech recognition errors have occurred and have been corrected.

That the original sound model becomes suitable for a non-specific speaker means that the original sound model is modified so that data that would be recognized with low probability by using the original sound model may be recognized with a high probability by using a newly adapted sound model. Thus, according to an exemplary embodiment, the speaker adaptation apparatus 100 prevents the speech recognition error from occurring in the speech data in the adapted sound model by using the speech data with low pattern similarity with the pattern of the original sound model as adapted data.

As described above, the database 110 may store data relating to the similarity between the parameters of input speech data and the parameters of the original sound model. The adapted data extracting unit 120 may extract the adapted data from the database 110 in an order beginning with speech recognition data containing speech data with the lowest similarity. That is, the adapted data extracting unit 120 may extract the adapted data by aligning recognition probability values, which are calculated when the speech data is recognized, in an ascending order so that as the recognition probability values are reduced, the probability that the adapted data to be extracted is increased, from each of the group of speech recognition data on which the speech recognition has been successfully performed and from the group of speech recognition data in which speech recognition errors have been corrected.

From each group of speech recognition data on which speech recognition has been successfully performed, and each group of speech recognition data in which speech recognition errors have been corrected, the adapted data extracting unit 120 may extract, simultaneously or separately, the adapted data in an order beginning with the speech recognition data containing the most words that are most frequently used. This is because a sound model suitable for a specific speaker may be generated when words the used as the adapted data are words that are frequently used according to the specific speaker's linguistic habits or living environment.

When the adapted data is extracted from the group of speech recognition data in which speech recognition errors have been corrected, in order to prevent errors from occurring with respect to words in which many errors occur in the original sound model, in a new sound model in which the words are adapted, the adapted data extracting unit 120 may extract the adapted data in an order beginning with speech recognition data containing the most words with the highest error occurrence. For example, the adapted data extracting unit 120 may extract adapted sentences in an order beginning with sentences containing the most words with the highest error occurrence. In addition, when the number of words with error occurrences are the same in different sentences, the adapted data extracting unit 120 may select a sentence containing more words with higher accumulated times as the adapted data.

The adapted data extracting unit 120 selects adapted data from different kinds of groups of speech recognition data, and transmits the adapted data to the speaker adaptation unit 130.

The speaker adaptation unit 130 forms a modification equation by using the adapted data transmitted from the adapted data extracting unit 120, and modifies the original sound model to create a new sound model suitable for a specific speaker by using the modification equation.

According to an exemplary embodiment, the speaker adaptation unit 130 modifies the original sound model by using the adapted data extracted from the group of speech recognition data on which the speech recognition has been successfully performed, and by using the adapted data extracted from the group of speech recognition data in which speech recognition errors have been corrected, as input data of different respective adaptation methods.

As described above, the speaker adaptation apparatus 100 extracts the speech data having low similarity with patterns of the original sound model as the adapted data. Thus, the similarity of the adapted data extracted from the group of speech recognition data on which the speech recognition has been successfully performed is not optimum even though speech recognition errors do not occur when the speech data is recognized using the original sound model. This means the original sound model and the adapted sound model have a predetermined offset from an overall point of view, but not from a local point of view.

According to an exemplary embodiment, the speaker adaptation unit 130 may entirely modify the original sound model so as to be suitable for characteristics of the speaker by performing a global adaptation method using the adapted data extracted from the group of speech recognition data in which no speech recognition error occurs.

The global adaptation method applies the same adaptation method to information without adaptation data by using the adapted data, and entirely modifies the original sound model so as to be suitable for a specific speaker.

A representative method of the global adaptation method is a regression-based speaker adaptation method. When outlier data, which has entirely different variation amounts and different characteristics, is contained in the adapted data, the performance of the regression-based speaker adaptation method is reduced. According to an exemplary embodiment, the adapted data is sorted into two kinds of data, and the glottal adaptation method is performed using the adapted data extracted from the group of speech recognition data on which the speech recognition has been successfully performed, and thus the regression performance of the regression based speaker adaptation method may be maximized by reducing the outlier data having entirely different variation amounts and different characteristics.

According to an exemplary embodiment, the speaker adaptation unit 130 may use a maximum likelihood linear regression (MLLR) of the global adaptation method. The MLLR method may effectively modify a sound model using a small amount of data by applying a linear regression method of binding models having similar characteristics, but this is an example only. That is, the global adaptation method performed by the speaker adaptation unit 130 is not limited to the MLLR method.

The adapted data extracted from the group of speech recognition data in which speech recognition errors have been corrected is not consistently different from the original sound model due to the occurrences of the speech recognition errors, and thus it is proper to individually adapt models with respect to which speech recognition errors have occurred.

According to an exemplary embodiment, to perform a local adaptation, the speaker adaptation unit 130 adapts, with regard to a specific speaker, only a model with respect to which a speech recognition error occurred in the original sound model by using the adapted data extracted from the group of speech recognition data in which a speech recognition error occurred.

A representative method of the local adaptation method may be a maximum a posteriori (MAP) adaptation method. In a MAP method, a subject parameter to be predicted is assumed to be a random parameter, and experimental information about the subject parameter is used.

However, this is an example only, and the local adaptation method performed by the speaker adaptation unit 130 is not limited to being a MAP method.

According to an exemplary embodiment, since adaptation performance of the speaker adaptation method varies based on the adapted data that is used, speech data on which speech recognition has been previously performed, and in which characteristics of a user's speech are reflected may be used as the adapted data.

According to an exemplary embodiment, the adapted data is extracted from the group of speech recognition data on which the speech recognition has been successfully performed, and also from the group of speech recognition data in which speech recognition errors have been corrected, and an adaptation method suitable for the extracted adapted data may be selectively used.

According to an exemplary embodiment, when a speech recognition error occurs due to a speaker providing speech data in a very noisy environment, environment adaptation as well as speaker adaptation may be performed by using speech recognition data containing many words in which speech recognition errors have occurred as adapted data.

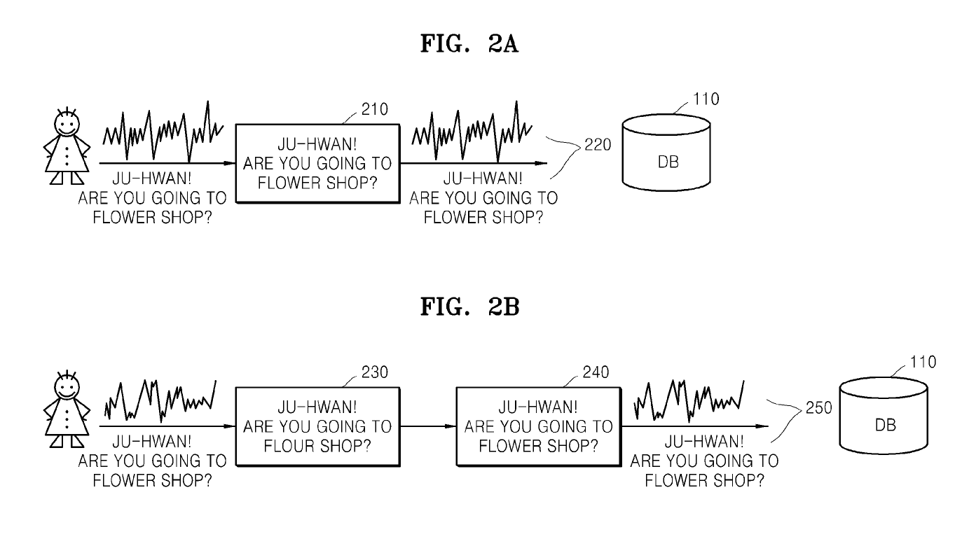

FIGS. 2A and 2B are diagrams for explaining an operation of storing speech recognition data in the database 110, according to an exemplary embodiment.

FIGS. 2A and 2B show that the speech recognition data stored in the database 110 is different when speech recognition is correctly performed, as compared to when the speech recognition is not correctly performed.

As shown on the left side of FIG. 2A, when a speaker says “Ju-hwan! Are you going to the flower shop?”, a waveform of speech data provided by the speaker is shown.

A speech recognition apparatus (not shown) extracts a characteristic parameter or a characteristic vector from the input speech data provided by the speaker, compares the characteristic parameter or the characteristic vector with a parameter of the original sound model, and outputs data with the highest similarity to the speech data in the form of text data 210.

The speaker may notice that speech recognition has been correctly performed on the speech data provided by the speaker through the text data 210 output from the speech recognition apparatus. The speaker transmits information, which indicates that the speech recognition has been correctly performed, to the speech recognition apparatus through an input unit (not shown) such as a keyboard, a button, or the like.

When the speech recognition apparatus receives the information from the speaker indicating that the speech recognition has been correctly performed, the speech recognition apparatus transmits this information to the speaker adaptation apparatus 100. When the speech recognition has been correctly performed, the speaker adaptation apparatus 100 binds the waveform of the input speech data provided by the speaker, a characteristic vector or characteristic parameter of the input speech data, and text data corresponding to the input speech data provided by the speaker, and stores the bound data as speech data 220 in the database 110.

In FIG. 2B, when the speaker says “Ju-hwan! Are you going to the flower shop?”, the speech recognition apparatus compares the input speech data provided by the speaker with a parameter of the original speech model, and outputs data with the highest similarity in the form of text data 230. When the speech recognition apparatus recognizes the speech data as “Ju-hwan! Are you going to the flouer shop?”, the speaker may notice that the speech recognition has not been correctly performed on the input speech data.

The speaker may correct a phoneme or a word in which speech recognition errors have occurred through an input unit such as a keypad, or the like. In FIG. 2B, text data 240 including words formed by correcting the word “flouer” to the word “flower” may be generated.

When the speech recognition apparatus receives the correction of the text data 230 from the speaker, the speech recognition apparatus determines that a speech recognition error has occurred, and the speech recognition apparatus notifies the speaker adaptation apparatus 100 about the speech recognition error. When a speech recognition error has occurred, the speaker adaptation apparatus 100 stores, in the database 110, a waveform of the input speech data provided by the speaker, or a characteristic vector or a characteristic parameter of the input speech data, and speech recognition data 250 including the corrected text data.

Likewise, according to an exemplary embodiment, speech recognition data may be sorted, and stored in a database, according to whether the speech recognition has been correctly performed, or whether a speech recognition error occurred and has been corrected.

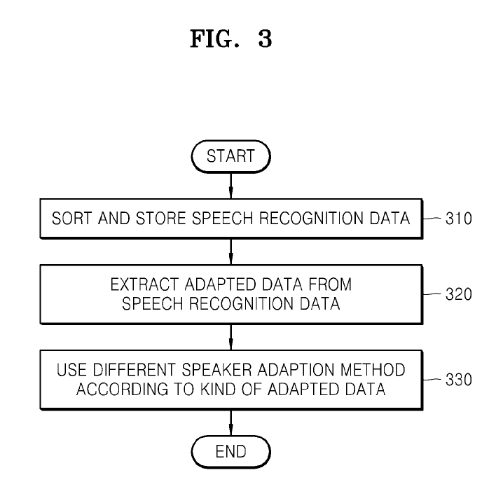

FIG. 3 is a flowchart of a speaker adaptation method according to an exemplary embodiment. Referring to FIG. 3, the speaker adaptation apparatus 100 sorts data that is provided by a speaker and on which speech recognition is performed, according to whether the recognition has been correctly performed, and stores the sorted data in the database 110 (operation 310).

The speaker adaptation apparatus 100 extracts adapted data from the database 110 (operation 320). The speaker adaptation apparatus 100 extracts the adapted data from a group of speech recognition data on which the speech recognition has been successfully performed, and also from a group of speech recognition data in which speech recognition errors occurred and have been corrected.

The speaker adaptation apparatus 100 performs another speaker adaptation method by using the adapted data from the group of speech recognition data on which the speech recognition has been successfully performed, and also from the group of speech recognition data in which speech recognition errors occurred and have been corrected (operation 330).

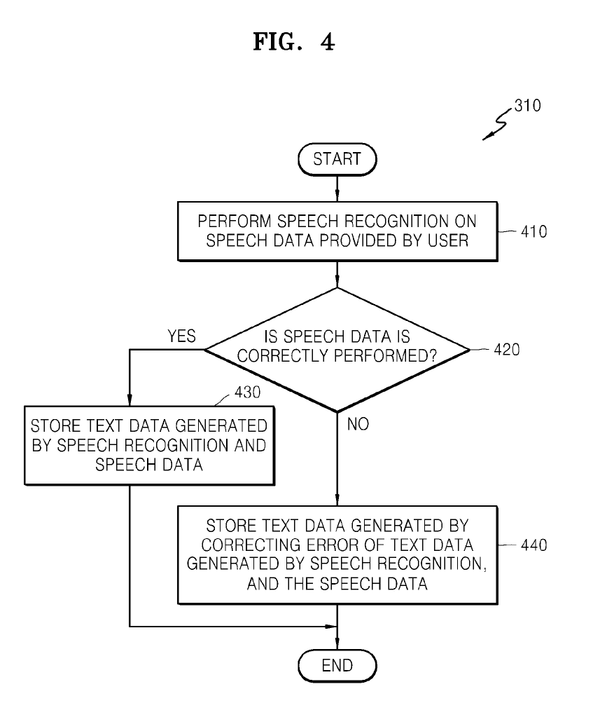

FIG. 4 is a flowchart of operation 310 of FIG. 3, according to an exemplary embodiment. Referring to FIG. 4, a speech recognition apparatus (not shown) performs the speech recognition on the input speech data provided by the speaker (operation 410).

The speech recognition apparatus may output data with the highest similarity to the input speech data in the form of text data. The speaker determines whether the text data corresponds to the input speech data provided by the speaker, and the speaker notifies the speech recognition apparatus about the determination. When the text data does not correspond to the input speech data, the speaker may correct a portion of the text data in which an error has occurred.

The speaker adaptation apparatus 100 receives information from the speaker indicating whether the text data corresponds to the input speech data, and thereby determines whether the speech recognition has been correctly performed on the input speech data (operation 420).

The speaker adaptation apparatus 100 sorts and stores the speech data according to whether the speech recognition has been correctly performed, or whether a speech recognition error has occurred.

When the speaker adaptation apparatus 100 determines that the speech recognition has been correctly performed on the input speech data, the speaker adaptation apparatus 100 stores the text data generated by recognizing the input speech data and the input speech data as speech recognition data in the database 110 (operation 430).

When the speaker adaptation apparatus 100 determines that the speech recognition has not been correctly performed on the input speech data, the speaker adaptation apparatus 100 stores text data generated by correcting an error in the text data generated by the speech recognition, and the input speech data as the speech recognition data in the database 110 (operation 440).

Likewise, according to an exemplary embodiment, in order to sort adapted data suitable for the speaker, speech recognition data in which the speaker's speech characteristics are reflected may be sorted and stored according to whether the speech recognition has been successfully performed.

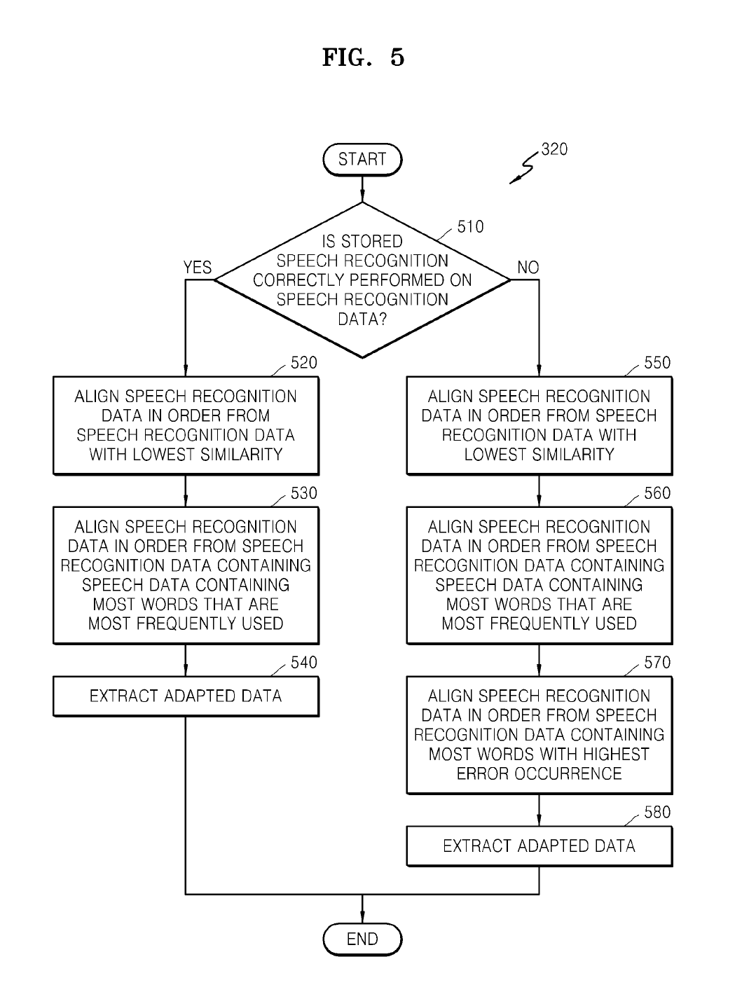

FIG. 5 is a flowchart of operation 320 of FIG. 3, according to an exemplary embodiment.

Referring to FIG. 5, the speaker adaptation apparatus 100 determines whether speech recognition data stored in the database 110 was correctly performed, or whether it included a speech recognition error which has been corrected (operation 510).

The speaker adaptation apparatus 100 extracts the adapted data from a group of speech recognition data on which the speech recognition was successfully performed, and also from a group of the speech recognition data in which speech recognition errors occurred and were corrected.

The speaker adaptation apparatus 100 aligns speech recognition data contained in the group of speech recognition data on which the speech recognition was successfully performed in an order beginning with speech recognition data with the lowest similarity, in order to extract the adapted data from the group of the speech recognition data on which the speech recognition was successfully performed (operation 520).

Simultaneously, or separately, the speaker adaptation apparatus 100 aligns the speech recognition data in an order beginning with speech recognition data containing speech data containing the most words that are most frequently used (operation 530).

The speaker adaptation apparatus 100 extracts speech recognition data containing the most words with the lowest similarity and/or that are most frequently used as the adapted data from the aligned speech recognition data (operation 540).

The speaker adaptation apparatus 100 aligns speech recognition data contained in the group of speech recognition data in which speech recognition errors occurred and were corrected, in an order beginning with speech recognition data with the lowest similarity, in order to extract the adapted data from the group of speech recognition data in which speech recognition errors occurred and were corrected (operation 550).

Simultaneously, or separately, the speaker adaptation apparatus 100 aligns the speech recognition data in an order beginning with speech recognition data containing speech data containing the most words that are most frequently used (operation 560).

Simultaneously, or separately, the speaker adaptation apparatus 100 aligns the speech recognition data in an order beginning with speech recognition data containing the most words with the highest error occurrence (operation 570).

The speaker adaptation apparatus 100 extracts adapted data from the aligned speech recognition data (operation 580). The speaker adaptation apparatus 100 extracts speech recognition data containing the most words with the lowest similarity and/or that are most frequently used as the adapted data and/or with the highest error occurrence from the aligned speech recognition data (operation 580).

Likewise, according to an exemplary embodiment, the speaker adaptation apparatus may extract adapted data from the group of speech recognition data on which the speech recognition was correctly performed, and also from the group of speech recognition data on which the speech recognition was not correctly performed.

In addition, the speaker adaptation apparatus may align the speech recognition data according to any one of similarity, usage frequency, and error occurrence, and may select adapted data therefrom.

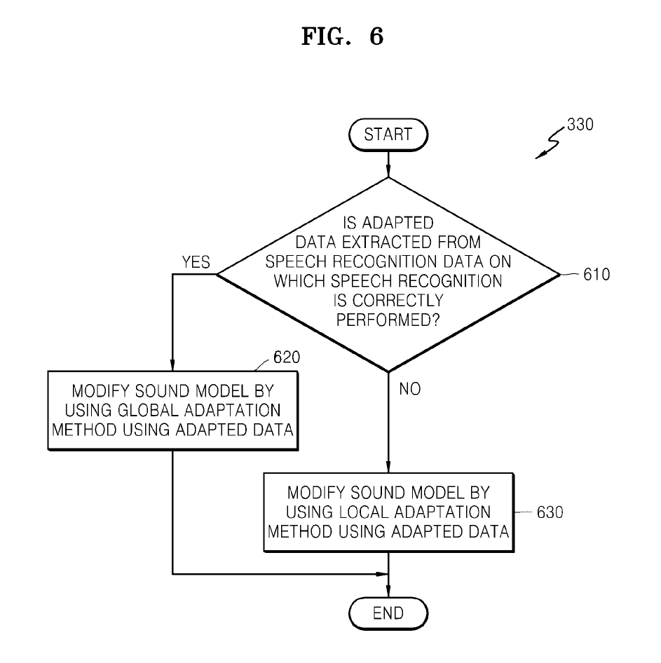

FIG. 6 is a flowchart of operation 330 of FIG. 3, according to an exemplary embodiment. Referring to FIG. 6, the speaker adaptation apparatus 100 determines whether adapted data is extracted from the group of speech recognition data on which the speech recognition was correctly performed or the group of speech recognition data in which speech recognition errors occurred and were corrected (operation 610).

When the speaker adaptation apparatus 100 extracts the adapted data from the group of speech recognition data on which the speech recognition was correctly performed, the speaker adaptation apparatus 100 entirely modifies the original sound model by performing a global adaptation method using the adapted data (operation 620).

When the speaker adaptation apparatus 100 extracts the adapted data from the group of speech recognition data in which speech recognition errors occurred and were corrected, the speaker adaptation apparatus 100 individually modifies only a sound model with respect to which an error occurred from among the original sound models by performing a local adaptation method using the adapted data (operation 630).

According to an exemplary embodiment, a sound model may be modified using various adaptation methods according to characteristics of the adapted data.

While exemplary embodiments have been particularly shown and described, it will be understood by those of ordinary skill in the art that various changes in form and details may be made therein without departing from the spirit and scope of the present inventive concept as defined by the following claims.

What is claimed is:

1. A speaker adaptation method comprising:
extracting adapted data from speech recognition data stored in a database, wherein the stored speech recognition data comprises a first type of data and a second type of data;
selecting a speaker adaptation method according to whether the extracted data comprises the first type of data or the second type of data; and
modifying a sound model by using the selected speaker adaptation method.

2. The speaker adaptation method of claim 1, further comprising storing the speech recognition data in the database,
wherein the speech recognition data comprises input speech data on which speech recognition has been performed using a sound model.

3. The speaker adaptation method of claim 2, wherein
the first type of data comprises speech recognition data for which the speech recognition was correctly performed and the second type of data comprises speech recognition data for which the speech recognition was not correctly performed, and
the storing of the speech recognition data comprises sorting the speech recognition data into the first type of data and the second type of data.

4. The speaker adaptation method of claim 3, wherein the first type of data comprises text data generated by recognizing the input speech data, in addition to the input speech data.

5. The speaker adaptation method of claim 3, wherein the second type of data comprises text data generated when an error in text data generated by recognizing the input speech data was corrected, in addition to the input speech data.

6. The speaker adaptation method of claim 3, wherein the extracting of the adapted data comprises, extracting the second type of data in an order beginning with speech recognition data containing most words with a highest error occurrence.

7. The speaker adaptation method of claim 3, wherein the extracting of the adapted data comprises extracting the adapted data in an order beginning with speech recognition data containing speech data with a lowest pattern similarity to a pattern of the sound model.

8. The speaker adaptation method of claim 3, wherein the extracting of the adapted data comprises extracting the adapted data in an order beginning with speech recognition data containing speech data containing most words that are most frequently used.

9. The speaker adaptation method of claim 3, wherein, when the adapted data comprises the first type of data, the modifying the sound model comprises using a global adaptation method using the extracted adapted data.

10. The speaker adaptation method of claim 9, wherein the global adaptation method is a maximum likelihood linear regression method.

11. The speaker adaptation method of claim 3, wherein, when the adapted data comprises the second data, modifying the sound model comprises using a local adaptation method using the extracted adapted data.

12. The speaker adaptation method of claim 11, wherein the local adaptation method comprises a maximum a posteriori method.

13. A speaker adaptation apparatus comprising:
a database in which speech recognition data is stored, wherein the speech recognition data comprises a first type of data and a second type of data;
an adapted data extracting unit which extracts adapted data from speech recognition data stored in the database; and
a speaker adaptation unit which modifies a sound model by using a speaker adaptation method based on whether the extracted data comprises the first type of data or the second type of data.

14. The speaker adaptation apparatus of claim 13, wherein the speech recognition data comprises input speech data on which speech recognition has been performed using a sound model.

15. The speaker adaptation apparatus of claim 14, wherein
the first type of data comprises speech recognition data for which the speech recognition was correctly performed and the second type of data comprises speech recognition data for which the speech recognition was not correctly performed.

16. The speaker adaptation apparatus of claim 15, wherein the first type of data comprises text data generated by recognizing the input speech data, in addition to the input speech data.

17. The speaker adaptation apparatus of claim 15, wherein the second type of data comprises text data generated when an error in text data generated by recognizing the input speech data was corrected, in addition to the input speech data.

18. The speaker adaptation apparatus of claim 15, wherein, when the extracted adapted data is the second type of data, the adapted data extracting unit extracts the adapted data in an order beginning with speech recognition data containing most words with a highest error occurrence.

19. The speaker adaptation apparatus of claim 15, wherein the adapted data extracting unit extracts the adapted data in an order beginning with speech recognition data containing speech data with a lowest pattern similarity to a pattern of the sound model.

20. The speaker adaptation apparatus of claim 15, wherein the adapted data extracting unit extracts the adapted data in an order beginning with speech recognition data containing speech data containing most words that are most frequently used.

21. The speaker adaptation apparatus of claim 15, wherein, when the extracted adapted data comprises the first type of data, the speaker adaptation unit modifies the sound model by using a global adaptation method using the extracted adapted data.

22. The speaker adaptation apparatus of claim 21, wherein the global adaptation method is a maximum likelihood linear regression method.

23. The speaker adaptation apparatus of claim 15, wherein, when the extracted adapted data is the second type of data, the speaker adaptation unit modifies the sound model by using a local adaptation method using the extracted adapted data.

24. The speaker adaptation apparatus of claim 23, wherein the local adaptation method comprises a maximum a posteriori method.

25. A non-transitory computer readable recording medium having recorded thereon a program for executing a method comprising:
extracting adapted data from speech recognition data stored in a database, wherein the stored speech recognition data comprises a first type of data and a second type of data;
selecting a speaker adaptation method according to whether the extracted data comprises the first type of data or the second type of data; and
modifying a sound model by using the selected speaker adaptation method.

26. A speaker adaptation method comprising:
extracting speech recognition data from a database, wherein the speech recognition data comprises one of a first type of data and a second type of data, wherein the first type of data comprises input speech data and data generated by correctly recognizing the input speech data, and the second type of data comprises input speech data and data generated when an error in text data generated by incorrectly recognizing the input speech data is corrected;
selecting a first speaker adaptation method when the extracted speech recognition data comprises the first type of data, and selecting a second speaker adaptation method, different from the first speaker adaptation method, when the extracted speech recognition data comprises the second type of data; and
modifying a sound model using the selected speaker adaptation method.
